(19) United States
(12) Patent Application Publication
(10) Pub. No.: US 2026/0231114 A1
(43) Pub. Date: Aug. 6, 2026

(54) IMPROVEMENTS RELATING TO PAGING NETWORK CONTROLLED REPEATER

(71) Applicant: Samsung Electronics Co., Ltd., Suwon-si, Gyeonggi-do (KR)

(72) Inventors: Jonas SEDIN, Staines (GB); Milos TESANOVIC, Staines (GB); Mahmoud WATFA, Staines (GB)

(21) Appl. No.: 19/155,113

(22) PCT Filed: Feb. 7, 2024
(86) PCT No.: PCT/KR2024/001833

§ 371 Date: Aug. 8, 2025

(30) Foreign Application Priority Data
Feb. 9, 2023 (GB) 2301856.7
Jan. 9, 2024 (GB) 2400310.5

(51) Int. Cl. H04W 68/02; H04W 76/20; H04W 76/30; H04W 92/18

(52) U.S. Cl. CPC H04W 68/02; H04W 76/20; H04W 76/30; H04W 92/18

(57) ABSTRACT

The disclosure relates to a 5G or 6G communication system for supporting a higher data transmission rate. A method performed by a base station in a wireless communication system is provided. The method comprises identifying to page a network controlled repeater (NCR), transmitting, to the NCR, a first message including configuration information on the NCR and receiving, from the NCR, a second message for a connection establishment as a response to the first message.

### TECHNICAL FIELD

The present disclosure relates to a wireless communication system, and more specifically a network-controlled repeater (NCR) which is an entity found in a telecommunication system.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

A method performed by a base station in a wireless communication system is provided. The method comprises identifying to page a network controlled repeater (NCR), transmitting, to the NCR, a first message including configuration information on the NCR and receiving, from the NCR, a second message for a connection establishment as a response to the first message.

A base station in a wireless communication system is provided. The base station comprises a transceiver and a controller coupled with the transceiver and configured to identify to page a network controlled repeater (NCR), transmit, to the NCR, a first message including configuration information on the NCR, and receive, from the NCR, a second message for a connection establishment as a response to the first message.

A method performed by a network controlled repeater (NCR) in a wireless communication system is provide. The method comprises receiving, from a base station, a first message including configuration information on the NCR and transmitting, to the base station, a second message for a connection establishment as a response to the first message.

A network controlled repeater (NCR) in a wireless communication system is provided. The NCR comprises a transceiver and a controller coupled with the transceiver and configured to receive, from a base station, a first message including configuration information on the NCR, and transmit, to the base station, a second message for a connection establishment as a response to the first message.

### BRIEF DESCRIPTION OF DRAWINGS

The proposed system and method are illustrated in the accompanying drawings, throughout which like reference letters indicate corresponding parts in the various figures. The embodiments herein will be better understood from the following description with reference to the drawings, in which:

FIG. 1 illustrates a network controlled repeater communication architecture according to an embodiment;

FIG. 2A illustrates a core network and inter-node signaling for paging purposes according to an embodiment;

FIG. 2B illustrates a core network and inter-node signaling for paging purposes according to an embodiment;

FIG. 3A illustrates initiating paging by a gNB and indicating initiating the paging to the AMF, and performing paging but network does not update 5G-S-TMSI after paging, respectively, according to an embodiment.

FIG. 3B illustrates initiating paging by a gNB and indicating initiating the paging to the AMF, and performing paging but network does not update 5G-S-TMSI after paging, respectively, according to an embodiment.

FIG. 4 illustrates performing paging using signaled 5G-S-TMSIs according to an embodiment.

FIG. 5 illustrates paging procedures for an NCR-MT according to an embodiment.

FIG. 6 illustrates moving NCR-MT to 5GMM-CONNECTED upon being paged and transitioning from RRC_IDLE, according to an embodiment.

FIG. 7 illustrates Paging Request to start the paging procedures according to an embodiment; and

FIG. 8 illustrates an NCR-MT being paged in idle mode with i-RNTI according to an embodiment.

### BEST MODE FOR CARRYING OUT THE INVENTION

It applies particularly, but not exclusively to Fifth Generation (5G) or New Radio (NR) systems, but may find utility in other types of network

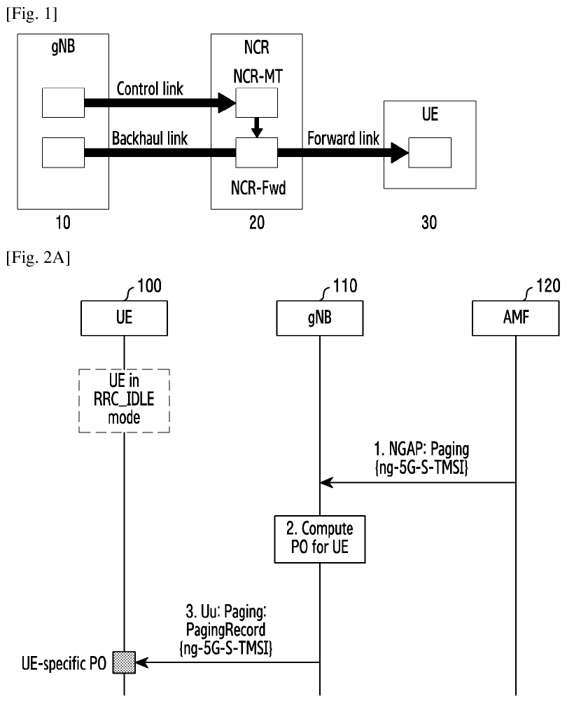

The Network Controlled Repeater (NCR) is a Release 18 feature to introduce a repeater for coverage purposes that is controlled by the network. The network architecture of NCR communication is as seen in FIG. 1. FIG. 1 illustrates a base station (e.g., gNB) 10 which is communicatively coupled to an NCR 20 and onto a User Equipment (UE) 30.

One of the key features to allow for easy deployments of NCR is that it shall be transparent to a UE 30 whether it is communicating through an NCR 20 or not. In other words, the UE is unaware of the presence of the NCR and believes it is communicating directly with the base station 10.

The NCR-MT (Mobile Termination) part of the NCR, is expected to function almost like a normal UE, meaning that the NCR-Fwd (e.g, NCR-MT) configurations are signalled via NCR-MT. This means that NCR-MT will have a full protocol stack, but it is expected that some functionality that is normally used by a UE may not be applicable and will not be implemented by the NCR-MT and/or configured by the network. For example, the NCR-Fwd is referred to the NCR forwarding.

Some idle/inactive mode UE procedures relevant to NCR include:
Public Land Mobile Network (PLMN) selection
   The UE scans and reports detected PLMN to Non-Access Stratum (NAS). A PLMN is reported as a high quality PLMN in case that the measured Reference Signal Received Power (RSRP) value is greater than-110 dBm.
Cell selection
   UE selects an (often initial) cell based on two criteria known as the Cell selection criteria. The UE selects a cell that fulfils the criteria, but it is not specified which of the cells the UE shall select. The criteria are based on the received power level as well as the quality of the signal, which are, in turn, based on signalled thresholds and measurements.
Cell reselection
   Cell reselection is for the UE to camp on the most suitable cell. In addition to the cell selection criteria, the UE also ranks different cells of the same priority to choose the best cell (or, a cell which satisfy the criteria). The UE also measures on different frequencies that have either high or lower priority, which ensures that the UE always camps on the best cell with the highest priority.
Location registration and Radio Access Network (RAN) Area Registration
   Tracking Area registration/update—The UE reports the tracking area information to NAS. And if a UE camps on a new tracking area a Tracking Area Update is triggered. This can also be done periodically.
   RAN Area Registration—The UE performs a RAN-based notification area update when the UE camps on a new cell that does not belong to the current ran notification area (RNA). This can also be done periodically.

Also relevant is the radio resource control (RRC) Inactive state. RRC inactive is a state in which the UE may move faster to connected mode compared to RRC idle to, for instance, perform data transmissions. It is faster due to the gNB maintaining the UE context when the UE is in inactive mode. This means that the UE does not need to reinitiate security and the UE does not need to be fully re-configured whenever the UE re-connects.

This mechanism is enabled by the UE being configured with a RNA in which the UE may camp within that area without having to notify RAN. In case that the UE detects another RAN Notification Area, the UE performs RNA Update procedures where the UE performs random access and includes the value rna-Update in the field resumeCause in message RRCResumeRequest.

Also relevant is paging. Paging is performed in order to allow for a network to be able to reach a UE when the UE is in a more power efficient state (RRC_IDLE or RRC_INACTIVE).

To read possible pages from the network, the UE monitors certain channels.

There are two main types of paging: Core Network-initiated paging; and RAN-initiated paging.

Core Network-initiated paging is due to presence of downlink data or Core Network signaling for the UE, while RAN-initiated paging is for a UE in RRC_INACTIVE (which may also be due to downlink data or signaling from a core network). A UE in RRC_IDLE only monitors for Core Network-initated paging, where a UE may use a default or UE-specific cycle. A UE in RRC_INACTIVE monitors for both Core Network-initiated and RAN-initiated paging. For monitoring for pages in RAN-initiated paging, the UE applies a UE-specific cycle. The Paging Frame (e.g., the Radio Frame within which a Paging Occasion occurs) and Paging Occasion (e.g., the specific subframe within a Radio Frame where the paging is signalled) of a UE is partly based on network configurations but also based on the ID of the UE, which is derived based on temporary UE identifier 5G-S-TMSI (Temporary Mobile Subscriber Identity). The UE_ID that is used to determine paging occasion is calculated as UE_ID=5G-S-TMSI mod 1024 (except for eDRX (Extended Discontinuous Reception) where it is calculated as UE_ID=5G-S-TMSI mod 4096). In case that the UE has not been allocated a 5G-S-TMSI, UE_ID=0 is used.

When a UE has detected a page being sent in one of its Paging Occasions, the UE checks (or, identify) whether the paging record matches its own identity. In general, a UE in RRC_IDLE checks whether the paging record matches its ng-5G-S-TMSI while a UE in RRC_INACTIVE checks whether the paging record matches its i-RNTI (Inactive-Radio Network Temporary Identifier). A UE in RRC_IDLE indicates to the upper layers regarding the received page, where the upper layers (e.g., NAS) will determine the course of action. A UE in RRC_INACTIVE will perform the RRC Resume procedure in case that the identity matches. The ng-5G-S-TMSI is given by an Access and Mobility Management Function (AMF) entity (or AMF) while a i-RNTI is given by a gNB in SuspendConfig.

As part of 5G-specific enhancements to protect against so called IMSI-catchers, whereby a relatively simple device can log and track (International Mobile Subscriber Identity) IMSIs based on paging, a UE will be assigned a new identifier after every successful paging attempt. This means that the 5G-S-TMSI and I-RNTI is required to be replaced after every successful paging procedure from RRC_IDLE and RRC_INACTIVE. This is specified in 3GPP TS 33.501 (Security architecture and procedures for 5G system).

To enable Core Network (CN) and RAN-based paging there are certain messaging protocols defined.

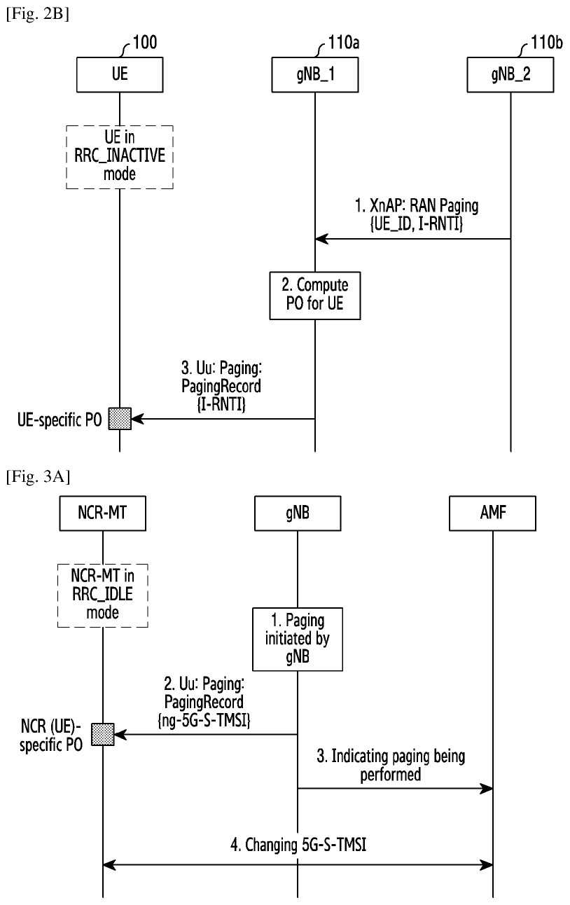

FIG. 2A illustrates a core network and inter-node signaling for paging purposes according to an embodiment.

For a Core Network (e.g., AMF) to enable a UE to page a UE, there is a specific message that is sent from AMF to gNB defined over Next Generation Application Protocol (NGAP); Paging. The Paging message contains a number of essential fields, and fields to assist the gNB. The NGAP message Paging contains the ng-5G-S-TMSI to allow a gNB to properly page any UE that the AMF has requested. The procedure can be seen in FIG. 2A, which illustrates the procedure as it relates to UE 100, gNB 110 and AMF 120.

Referring to FIG. 2A, at step 1 the AMF 120 transmits the NGAP message to the gNB 110. At step 2, the gNB 110 computes a paging occasion (PO) for the UE based on the NGAP message. At step 3, the gNB 100 transmits a paging message to the UE 100.

FIG. 2B illustrates gNBs and inter-node signaling for paging purposes according to an embodiment.

As RAN-based paging is initiated by a gNB 110 for a UE 100 in RRC_INACTIVE, which roams within the RAN Notification Area (RNA), there are XnAP messages defined to allow a gNB to ask another gNB to page the UE. This XnAP message is called RAN PAGING and for instance contains the UE identity index and UE RAN Paging Identity. The UE identity index is used for the gNB to determine which Paging Occasion to utilize without giving out the 5G-S-TMSI and the UE RAN Paging Identity which contains the I-RNTI, which is required for the UE to confirm the page is intended for it. This procedure can be seen in FIG. 2B, as it relates to the UE 100 and first and second gNBs 110a and 110b.

Referring to FIG. 2B, at step 1 the gNB2 transmits a message for the paging (e.g., XnAP messages) to the gNB1. At step 2, the gNB1 computes the PO based on the message. At step 3, the gNB 1 transmits a paging message to the UE 100.

Short message paging is also relevant. UEs in RRC_IDLE and RRC_INACTIVE both monitor for emergency indications (e.g., Earthquake and Tsunami Warning System (ETWS) and Commercial Mobile Alert System (CMAS)) through Short Messages that are signalled through a set of 1-bit indications via the physical layer (e.g., in Downlink Control Information (DCI)) using Paging-Radio Network Temporary Identifier, P-RNTI. Short Message may also contain indications regarding system information update and some other indications. The message is 8 bits in total.

This is defined in the relevant standard document TS 38.331, V 17.3.0 as:

### “6.5 Short Message

Short Messages can be transmitted on physical downlink control channel (PDCCH) using paging-RNTI (P-RNTI) with or without associated Paging message using Short Message field in DCI format 1_0 (see TS 38.212, clause 7.3.1.2.1).

Table 6.5-1 defines Short Messages. Bit 1 is the most significant bit.”

TABLE 6.5-1
Short Messages

| Bit | Short Message |
|---|---|
| 1 | systemInfoModification |
| | If set to 1: indication of a BCCH modification other than SIB6, SIB7 and |
| | SIB8. |
| 2 | etwsAndCmasIndication |
| | If set to 1: indication of an ETWS primary notification and/or an ETWS |
| | secondary notification and/or a CMAS notification. |
| 3 | stopPagingMonitoring |
| | This bit can be used for only operation with shared spectrum channel |
| | access and if nrofPDCCH-MonitoringOccasionPerSSB-InPO is present. |
| | If set to 1: indication that the UE may stop monitoring PDCCH occasion(s) |
| | for paging in this Paging Occasion as specified in TS 38.304, clause 7.1. |
| 4 | systemInfoModification-eDRX |
| | If set to 1: indication of a BCCH modification other than SIB6, SIB7 and |
| | SIB8. This indication applies only to UEs using eDRX cycle longer than the |
| | BCCH modification period. |
| 5-8 | Not used in this release of the specification, and shall be ignored by UE if |
| | received. |

5G-GUTI (5G Global Unique Temporary Identity) is a temporary identifier of a UE that is generated by the Core Network and is used to conceal the permanent entity of a UE. It is temporary and will often change for a UE. This is opposed to the SUPI (Subscription Permanent Identifier), which is a globally defined permanent identifier.

5G-S-TMSI (5G System Temporary Mobile Subscriber Identity) is the short version of the 5G-GUTI. The field name in RRC specifications is ng-5G-S-TMSI.

I-RNTI (Inactive Radio Network Temporary Identifier) is used during RAN-based paging procedure and is assigned to a UE by a gNB that is sent to RRC_INACTIVE mode.

During standardisation, the following was agreed:

### “Agreement:

NCR-MT supports RRC_CONNECTED and RRC_IDLE states, FFS on RRC_INACTIVE state (e.g. optional support or not support).

In the RAN2 #120 meeting the following was agreed:
WA: RRC_INACTIVE is optionally supported without any specific enhancements

### On NCR-Fwd ON/OFF:

When NCR-MT is in RRC_CONNECTED mode, the NCR-Fwd can be ON or OFF following the side control information received from the gNB.
After NCR-MT enters RRC_INACTIVE mode, the NCR-Fwd can be ON or OFF following the last configuration received from the gNB.
Release to RRC-IDLE is For Further Study.”

As can be seen above, RRC_IDLE is supported for an NCR-MT. However, in order to ensure that an NCR-MT can operate in RRC_IDLE, there needs to be a way for a donor gNB to be able to reach an NCR-MT in RRC_IDLE. This is especially important in case that the NCR is forwarding and there needs to be a reconfiguration of the NCR.

One of the reasons why releasing a NCR device to RRC_IDLE is “For Further Study” is that paging a UE in RRC_IDLE is usually initiated by the core network when there is downlink data destined for the UE. This means that in case that the RAN (donor gNB) wants to bring back the NCR, the ability to page an NCR node without the paging being initiated by the Core Network needs to be introduced. This is important to ensure consistent operation of an NCR node.

As there are security-related requirements when paging (related to the use of various network identifiers), there may be a need for new NCR-related procedures that are different from those used when paging a UE.

It is therefore an aim of embodiments of the present disclosure to address this and possibly other issues in the prior art, whether mentioned herein or not.

According to the present disclosure there is provided an apparatus and method as set forth in the appended claims. Other features of the disclosure will be apparent from the dependent claims, and the description which follows.

An aspect of the present disclosure relates to enabling an NCR-MT to be paged when in RRC_IDLE mode by a Donor gNB.

According to a first aspect of the present disclosure, there is provided a method for a base station, communicatively coupled to a telecommunication network, to page a repeater comprising the steps of determining to page the repeater, sending a Short Message to the repeater and receiving a connection establishment attempt from the repeater.

In an embodiment, the repeater is a Network Controlled Repeater, NCR.

In an embodiment, there is further provided the step of establishing a connection with the repeater.

In an embodiment, paging is performed using a Short Message and Downlink Control Information, DCI, with Paging-Radio Network Temporary Identifier, P-RNTI.

In an embodiment, a bit, ncr-Paging, is included in the Short Message specifically for a Mobile Termination, NCR-MT, part of the repeater.

In an embodiment, the Short Message includes a repeater identifier, NCR-RNTI, used for paging.

In an embodiment, a plurality of related repeaters are to be brought to connected mode simultaneously, whereby the plurality of NCR-MTs associated with the repeaters are assigned the same Paging Cycle and Paging Occasion.

In an embodiment, specific signalling is used or the plurality of NCR-MTs have UE_ID equal to zero or a specific number.

According to a second aspect of the present disclosure, there is provided a method for a repeater, operable to connect to a base station of a telecommunication network, comprising the steps of monitoring for paging messages from the base station, receiving a Short Message from the base station; decoding the Short Message and, if so signalled, establishing a connection to the base station.

In an embodiment, the repeater is in idle mode while monitoring for paging messages.

In an embodiment, when a Mobile Termination, MT, part of the repeater receives paging message targeting the repeater, the repeater switches NCR-Fwd off.

In an embodiment, a Mobile Termination, MT, part of the repeater does not inform upper layers of having received paging.

In an embodiment, a Mobile Termination, MT, part of the repeater only monitors for Radio Access Network, RAN, initiated paging.

In an embodiment, upon successful establishment of a connection, an MT part of the repeater transitions its NAS state from fifth generation mobility management (5GMM)-IDLE to 5GMM-CONNECTED mode.

According to a third aspect of the present disclosure, there is provided apparatus arranged to perform the method of any preceding aspect.

In an embodiment, the apparatus comprises a base station and a repeater.

Although a few preferred embodiments of the present disclosure have been shown and described, it will be appreciated by those skilled in the art that various changes and modifications might be made without departing from the scope of the invention, as defined in the appended claims.

For a better understanding of the disclosure, and to show how embodiments of the same may be carried into effect, reference will now be made, by way of example only, to the accompanying diagrammatic drawings in which:

Embodiments of the disclosure relate to methods for a Donor gNB to release an NCR device.

Herein, the notion of NCR-Fwd being “ON”/“OFF” could be that the NCR-Fwd is turned off as in the NCR does not forward anything, but could also be the notion that NCR-Fwd is turned off and any state or configuration related to NCR is turned off. As an example, in one scenario, the NCR will be configured with beam information that tells the NCR-Fwd at what times a slot shall be forwarded in which beam of the NCR. Thus, NCR-Fwd being turned “OFF” could, for instance, mean that the NCR-Fwd does not continue to forward anything, or that the forwarding configuration is discarded and/or a default forwarding configuration is applied.

An embodiment of the disclosure may apply to gNBs such as NG-RAN gNB. The disclosure may also apply to NCR-MTs in evolved universal terrestrial radio access (E-UTRA) new radio (NR)-dual connectivity (EN-DC), which means that certain embodiments may be carried out over E-UTRAN where the RRC messages may have different names. For instance, using the RRCResume (NR version) as opposed to RRCConnectionResume (E-UTRA version) should not be considered to indicate that the disclosure is targeting 5G NR only or 5G NR SA only. The skilled person will readily understand the conventions used and how adaptations may be made for alternative standards.

Note that NCR may be considered a “repeater node.”

A first option relates to paging procedures. In this embodiment, the NCR is paged using Core Network-initiated procedures, but without the Core Network being involved or being the initiator. The NCR-MT thus monitors either default paging cycle or paging cycle configured via NAS signaling and uses the 5G-S-TMSI as configured by the core network.

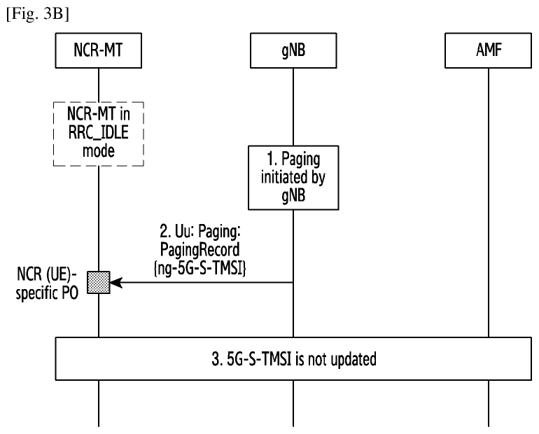

In this case the paging procedures are initiated by the gNB and pages in paging occasions based on the previously received 5G-S-TMSI. In one embodiment, gNB indicates to the core network about the paging and the 5G-S-TMSI is updated. In another embodiment, the gNB does not indicate to the core network about the paging and the 5G-S-TMSI is not updated. This may be considered secure as the NCR is a network entity without user data. Thus, the requirements may be relaxed for an NCR. These two examples can be seen in FIG. 3A and FIG. 3B.

Referring to FIG. 3A, at step 1, a paging (or, paging procedure) is initiated by the gNB. At step 2, the gNB transmits a paging message to the NCR-MT. At step 3, the gNB indicates a paging is performed to the AMF entity. At step 4, the gNB 5G-S-TMSI is changed based on the paging.

Referring to FIG. 3B, at step 1, a paging (or, paging procedure) is initiated by the gNB. At step 2, the gNB transmits a paging message to the NCR-MT. The 5G-S-TMSI is not updated.

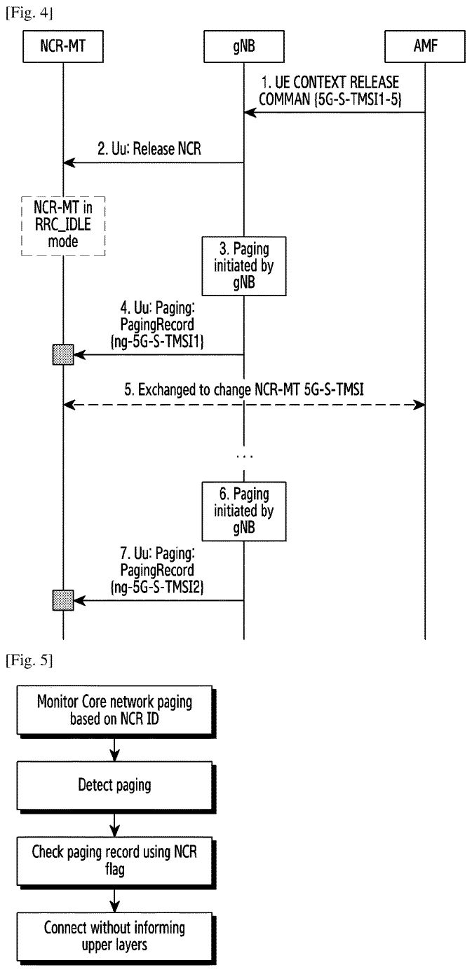

In another embodiment, the AMF configures the gNB to save and re-use at least one 5G-S-TMSI for paging the NCR. The AMF may provide at least one 5G-S-TMSI which has been allocated to the NCR-MT as part of the context release procedure For example, the AMF provides at least one 5G-S-TMSI in the UE CONTEXT RELEASE COMMAND message (which is sent on the N2 interface between the NG-RAN and the AMF). The AMF may allocate a set of 5G-S-TMSI for the NCR-MT in question and provide the set to the gNB, where the gNB may use the individual 5G-S-TMSI in a well-defined order (e.g. from the first to the last, or using a specific index that is incremented at every other paging). In this manner, the CN is also expected to use the same 5G-S-TMSI at each paging event such that both the gNB and the AMF would use the same identity. After the entire set is exhausted, or earlier, based on AMF policies, the AMF may then update the gNB with another set and so on. This procedure is illustrated in FIG. 4.

Referring to FIG. 4, at step1, the AMF transmits UE CONTEXT RELEASE COMMAN to the gNB. At step 2, the gNB transmits release message for the NCR to the NCR-MT. At step 3, a paging is initiated by the gNB. At step 4, the gNB transmits a paging message to the NCR-MT. At step 5, information is exchanged to change NCR-MR 5G-S-TMSI. At step 6, a paging is initiated by the gNB. At step 7, the gNB transmits a paging message to the NCR-MT.

A second option involves not having to deal with UE identifiers, where there are requirements for them to be updated due to security concerns. Instead, this option works with NCR-specific identifiers. Thus, in an embodiment, the NCR-paging is done using NCR-specific identifiers. This could, for instance, be done by including an NCR flag or an assigned NCR identifier in the PagingRecord. This can, for instance, be a ncr-RNTI. This can apply both for RRC_idle and RRC_inactive. An illustration of this procedure is shown in FIG. 5.

Referring to FIG. 5, the UE monitors a core network paging based on the NCR ID. The UE detects paging. For example, the UE identify the paging message received from the gNB. The UE checks (or, identify) paging record using the NCR flag. The UE transitions to the RRC connected state without informing upper layers.

One issue with the above is that the NCR-MT would still have to derive its Paging Occasion based on the ng-5G-S-TMSI. To address this problem there can be a number of solutions:

NCR-MT uses UE_ID=0
A. This is beneficial in the case where there may only be a single NCR device in the network and where security is not a concern

NCR-MT derives its Paging Frame and Paging Occasion based on a signaled NCR identity, which can be a bit string or integer assigned by a gNB or a Core network
B. This may not be required to change as often as any UE-identifiers

Some implementation examples of this in TS38.304 and TS38.331 can be seen in Illustrative Example #1, which follows later.

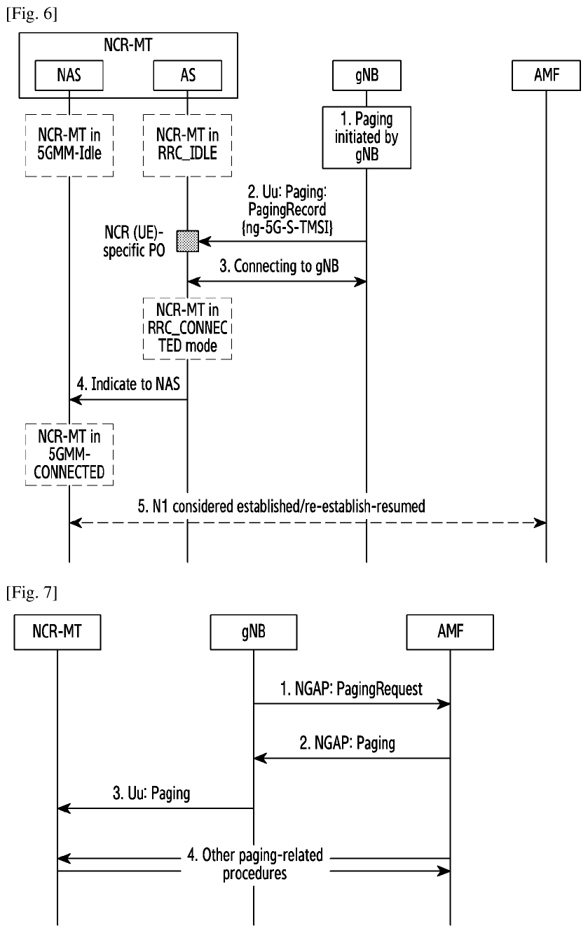

In this second option, in case that the NAS mode is 5GMM-IDLE, then the NAS will not be aware that the lower layers have gone to connected mode. To address this issue, when the RRC layer transitions to RRC_CONNECTED state, the RRC should inform the NAS about the transition to connected state and hence the NAS, based on this local indication, should transition to 5GMM-CONNECTED mode although the NAS has not sent any message to transition from 5GMM-IDLE mode to 5GMM-CONNECTED mode. In this case, the NAS should consider that a N1 (Signaling interface between AMF and UE) NAS signalling connection has been established (securely) even though no NAS message has been sent by the UE. Moreover, the NAS, based on a local transition without the sending of any NAS message, should consider that the NAS connection has been securely established and hence re-use the current 5G NAS security context. An example of this can be seen in FIG. 6.

Referring to FIG. 6, at step 1, a paging initiated by gNB. At step 2, the gNB transmits a paging message to the NCR-MT. At step 3, the NCR-MT is connected to the gNB. For example, the NCR-MT is in RRC_CONNECTED MODE. At step 4, the AS indicates to the NAS that the NCR-MT is in RRC_CONNECTED MODE. The NAS identify that the NCR-MT is in 5GMM-CONNCETED. At step 5, N1 is considered established/re-stablished-resumed.

In a third option, where the procedures are arranged to be as close to UE-paging procedures as possible, the gNB will indicate to the AMF to begin the paging procedures. This can be a message PagingRequest containing information about the NCR device and the related identifiers. The procedures can be seen in FIG. 7.

Referring to FIG. 7, at step 1, the gNB transmits to the AMF a first NGAP message (e.g., a paging request). At step 2, the AMF transmits a second NGAP message (e.g., paging) as a response to the first NGAP message. At step 3, the gNB transmits to the NCR-MT a paging message. At step 4, other paging-related procedures are performed.

To enable this, the AMF stores a mapping of the NCR device to the 5G-GUTI and, by extension, the 5G-S-TMSI. This mapping can be based on an NCR identifier, or there can be a mapping between NCR devices connected or associated with a specific gNB that gives the 5G-S-TMSI to be paged.

For instance, the PagingRequest message can contain an indication that the paging is for an NCR device.

This has the benefit that the following procedures may function similarly as for a UE, and the identifiers may also be updated as for a UE.

In an embodiment, when a gNB receives a Paging message from the AMF in response to a PagingRequest, the gNB maps this to the cells or frequencies where the NCR is likely to be present. This is needed as the Paging message usually contains a list of TAI (Tracking Area Indicators), which would not be needed when attempting to reach an NCR. The gNB may only perform this in case that it is in response to a PagingRequest message.

In a fourth option, the paging will be performed using Short Message and DCI with P-RNTI. This can be done by adding a bit ner-Paging in the Short Message specifically for an NCR-MT. This will signal to an NCR-MT to move to connected mode. This field is then ignored by non-NCR devices. This can be seen in Illustrative Example #2, which follows later.

In another embodiment a new Short Message is defined for an NCR-MT, which is used when a NCR-RNTI is used for paging. This can be seen in Illustrative Example #3, which follows later.

In the case where all the related NCR-MTs should be brought to connected mode at the same time, the NCR-MTs can be given the same Paging Cycle and Paging Occasion. This can be done through specific signaling, or the NCR-MTs can have UE_ID equal to zero or a specific number.

In a fifth option, the NCR-MT is given an i-RNTI as in RRC_INACTIVE to use to be paged on when the NCR-MT is in idle mode. This allows some other procedures to remain the same (RAN paging) and the NCR-MT can be considered to be in RRC_INACTIVE even though it is in RRC_IDLE. This also allows the NCR-MT's iRNTI to be updated every time the NCR-MT is paged again. During these procedures the ng-5G-S-TMSI remains the same.

This i-RNTI can be given to the NCR-MT when it is released via RRCRelease to RRC_IDLE. As opposed to RRC_INACTIVE, the UE is not given a suspend config to configure the i-RNTI.

When the NCR-MT further establishes connection with the gNB, the NCR-MT uses RRC setup procedures as is done when performing establishment after being paged in RRC_IDLE (as opposed to performing RRC Resume procedures when in RRC_INACTIVE).

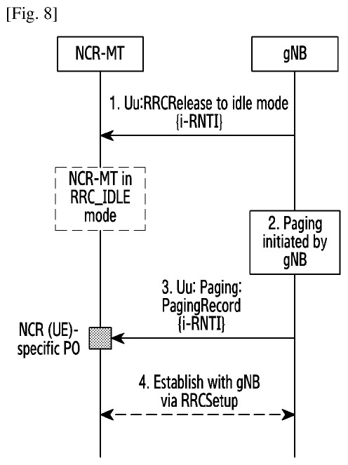

Part of this procedure can be seen in FIG. 8.

Referring to FIG. 8, at step 1, the gNB transmits to the NCR-MT an RRC release message to idle mode. The NCR-MT transitions to the RRC_IDLE mode. At step 2, a paging is initiated by the gNB. At step 3, the gNB transmits a paging message to the NCR-MT. At step 4, a connection is established with the gNB via RRC setup procedure.

In a further embodiment, when the NCR-MT receives paging message that targets the NCR-MT, the NCR-MT will switch NCR-Fwd to off. This can be useful to ensure cases where there is interference caused by NCR.

In a further embodiment, as the paging is triggered by RAN and subsequent actions are RAN-related, the UE does not inform upper layers of having received paging. An example of this can be seen in Example #4.

As the NCR-MT normally would only need to monitor indications from the gNB to move to RRC_CONNECTED in order to change any NCR-state, the UE may not need to monitor all the types of paging as a UE would be required to. Thus, in an embodiment, the UE only monitors one type of paging type. As an example, when the NCR-MT is RRC_INACTIVE, the NCR-MT only monitors RAN-initiated paging and not CN-initiated paging.

When being paged and establishing connection, there can be new causes such as ncr-Access. This may be needed as many of the current causes may not adequately explain why an NCR device is connecting to a gNB. This includes causes for:
Paging message (gNB to NCR-MT) in a field pagingCause-r18 with the value ncrPaging/ncr-Access,
RRCSetupRequest (NCR-MT to gNB—this is used to request to setup a connection with a gNB). This in the field establishmentCause with the value ncrAccess/ncr-Paging.
PAGING message (AMF to gNB) in the field Paging Cause with the value ‘ncr-Access’/‘ncr-Paging’
RAN Paging (gNB1 to gNB2) in the field Paging Cause with the value ‘ncr-Access’/‘ncr-Paging’

A UE normally monitors paging for System modification procedures, but for an NCR this may not be needed. Thus, in an embodiment, the NCR-MT ignores any emergency notifications. This means that in case that an emergency indication is sent using Short Message, the NCR device does not have to attempt to read any related System Information.

The following illustrative examples show suggested changes to the relevant standards specifications, reflecting the embodiments of the invention set out above. The changes to the version of the standards specification referenced are shown underlined.

### Illustrative Example #1—NCR-Specific Paging Flag

TABLE 1
TS38.331 V17.3.0

| | |
|---|---|
| 5.3.2.3 | Reception of the Paging message by the UE or PagingRecord by the L2 U2N |

Remote UE
Upon receiving the Paging message by the UE or receiving PagingRecord from its connected
L2 U2N Relay UE by a L2 U2N Remote UE, the UE shall:

| | |
|---|---|
| 1> | if in RRC_IDLE, for each of the PagingRecord, if any, included in the Paging |

message, or

| | |
|---|---|
| 1> | if in RRC_IDLE, for each of the PagingRecord, if any, included in the |

UuMessageTransferSidelink message received from the connected L2 U2N Relay UE:

| | |
|---|---|
| 2> | if the ue-Identity included in the PagingRecord matches the UE identity |

allocated by upper layers:

| | |
|---|---|
| 3> | if upper layers indicate the support of paging cause: |

| | |
|---|---|
| 4> | forward the ue-Identity, accessType (if present) and paging |

| | |
|---|---|
| | cause (if determined) to the upper layers; |
| 3> | else: |

| | |
|---|---|
| 4> | forward the ue-Identity and accessType (if present) to the |

upper layers;

| | |
|---|---|
| 1> | for NCR-MT in RRC_IDLE and RRC_INACTIVE, |
| | for each of the PagingRecord, |

if any, included in the Paging message, or

| | |
|---|---|
| 2> | if the ue-Identity includes ncr-MT: |

| | |
|---|---|
| 3> | consider the NCR-MT to be paged; |

<OMITTED>

TABLE 2
TS38.331 V17.3.0

- Paging
The Paging message is used for the notification of one or more UEs.
Signalling radio bearer: N/A
RLC-SAP: TM
Logical channel: PCCH
Direction: Network to UE
Paging message
-- ASN1START
-- TAG-PAGING-START

| Paging ::= | SEQUENCE { | |
|---|---|---|
| pagingRecordList | PagingRecordList | OPTIONAL, -- Need N |
| lateNonCriticalExtension | OCTET STRING | OPTIONAL, |
| nonCriticalExtension | Paging-v1700-IEs | OPTIONAL |

}

| Paging-v1700-IEs ::= | SEQUENCE { | |
|---|---|---|
| pagingRecordList-v1700 | PagingRecordList-v1700 | OPTIONAL, -- Need N |
| pagingGroupList-r17 | PagingGroupList-r17 | OPTIONAL, -- Need N |
| nonCriticalExtension | SEQUENCE { } | OPTIONAL |

}

| PagingRecordList ::= | SEQUENCE (SIZE (1..maxNrofPageRec) ) OF PagingRecord | |
|---|---|---|
| PagingRecordList-v1700 ::= | SEQUENCE (SIZE (1..maxNrofPageRec) ) OF PagingRecord-v1700 | |
| PagingGroupList-r17 ::= | SEQUENCE (SIZE (1..maxNrofPageGroup-r17) ) OF TMGI-r17 | |
| PagingRecord ::= | SEQUENCE { | |
| ue-Identity | PagingUE-Identity, | |
| accessType | ENUMERATED {non3GPP} | OPTIONAL, -- Need N |

...
}

| PagingRecord-v1700 ::= | SEQUENCE { | |
|---|---|---|
| pagingCause-r17 | ENUMERATED {voice} | OPTIONAL -- Need N |

}

| | |
|---|---|
| PagingUE-Identity ::= | CHOICE { |
| ng-5G-S-TMSI | NG-5G-S-TMSI, |
| fullI-RNTI | I-RNTI-Value, |

...,
[[

| | | |
|---|---|---|
| ncr-MT-r18 | ENUMERATED {true} | OPTIONAL -- Need N |

]]
}
-- TAG-PAGING-STOP
-- ASN1STOP

TABLE 3
TS38.331 V17.3.0
PagingRecord field descriptions

accessType
Indicates whether the Paging message is originated due to the PDU sessions from the non-
3GPP access.
pagingRecordList
If the network includes pagingRecordList-v1700, it includes the same number of entries, and
listed in the same order, as in pagingRecordList (i.e. without suffix).
pagingCause
Indicates whether the Paging message is originated due to IMS voice. If this field is present,
it implies that the corresponding paging entry is for IMS voice. If upper layers indicate the
support of paging cause and if this field is not present but pagingRecordList-v1700 is present,
it implies that the corresponding paging entry is for a service other than IMS voice. Otherwise,
paging cause is undetermined.

TABLE 4
TS38.304 V17.3.0

| | |
|---|---|
| 7 | Paging |
| 7.1 | Discontinuous Reception for paging |

The UE may use Discontinuous Reception (DRX) in RRC_IDLE and RRC_INACTIVE state in
order to reduce power consumption. The UE monitors one paging occasion (PO) per DRX
cycle. A PO is a set of PDCCH monitoring occasions and can consist of multiple time slots
(e.g. subframe or OFDM symbol) where paging DCI can be sent (TS 38.213). One Paging
Frame (PF) is one Radio Frame and may contain one or multiple PO(s) or starting point of a
PO. A L2 U2N Relay UE monitors the paging occasions of its PC5-RRC connected L2 U2N
Remote UEs. In this case, the DRX cycle and UE ID mentioned in this clause refer to those
of the L2 U2N Remote UE.
In multi-beam operations, the UE assumes that the same paging message and the same
Short Message are repeated in all transmitted beams and thus the selection of the beam(s)
for the reception of the paging message and Short Message is up to UE implementation. The
paging message is same for both RAN initiated paging and CN initiated paging.
The UE initiates RRC Connection Resume procedure upon receiving RAN initiated paging. If
the UE receives a CN initiated paging in RRC_INACTIVE state, the UE moves to RRC_IDLE
and informs NAS. However, if a L2 U2N Relay UE in RRC_INACTIVE state receives a CN
initiated paging for a L2 U2N Remote UE, the L2 U2N Relay UE does not move to RRC_IDLE
state.

| NOTE 0a: | The L2 U2N Remote UE does not need to monitor the PO in order to |
|---|---|
| receive the paging message. | |
| NOTE 0b: | While the SDT procedure is ongoing in RRC_INACTIVE state, the UE |

monitors the PO in order to receive only the Short Message as specified in TS 38.331.

The PF and PO for paging are determined by the following formulae:

SFN for the PF is determined by:

(SFN + PF_offset) mod T = (T div N)*(UE_ID mod N)

Index (i_s), indicating the index of the PO is determined by:

i_s = floor (UE_ID/N) mod Ns

The PDCCH monitoring occasions for paging are determined according to
pagingSearchSpace as specified in TS 38.213 and firstPDCCH-MonitoringOccasionOfPO
and nrofPDCCH-MonitoringOccasionPerSSB-InPO if configured as specified in TS 38.331.
When SearchSpaceId = 0 is configured for pagingSearchSpace, the PDCCH monitoring
occasions for paging are same as for RMSI as defined in clause 13 in TS 38.213.
When SearchSpaceId = 0 is configured for pagingSearchSpace, Ns is either 1 or 2. For Ns =
1, there is only one PO which starts from the first PDCCH monitoring occasion for paging in
the PF. For Ns = 2, PO is either in the first half frame (i_s = 0) or the second half frame (i_s =
1) of the PF.
When SearchSpaceId other than 0 is configured for paging SearchSpace, the UE monitors the
(i_s + 1)^{th} PO. A PO is a set of ‘S*X’ consecutive PDCCH monitoring occasions where ‘S’ is
the number of actual transmitted SSBs determined according to ssb-PositionsinBurst in SIB1
and X is the nrofPDCCH-MonitoringOccasionPerSSB-InPO if configured or is equal to 1
otherwise. The [x*S+K]^{th} PDCCH monitoring occasion for paging in the PO corresponds to
the K^{th} transmitted SSB, where x=0,1,...,X-1, K=1,2,...,S. The PDCCH monitoring occasions
for paging which do not overlap with UL symbols (determined according to tdd-UL-DL-
ConfigurationCommon) are sequentially numbered from zero starting from the first PDCCH
monitoring occasion for paging in the PF. When firstPDCCH-MonitoringOccasionOfPO is
present, the starting PDCCH monitoring occasion number of (i_s + 1)^{th} PO is the (i_s + 1)^{th}
value of the firstPDCCH-MonitoringOccasionOfPO parameter; otherwise, it is equal to i_s *
S*X. If X > 1, when the UE detects a PDCCH transmission addressed to P-RNTI within its
PO, the UE is not required to monitor the subsequent PDCCH monitoring occasions for this
PO.

| | |
|---|---|
| NOTE 1: | A PO associated with a PF may start in the PF or after the PF. |
| NOTE 2: | The PDCCH monitoring occasions for a PO can span multiple radio |

frames. When SearchSpaceId other than 0 is configured for paging-SearchSpace the
PDCCH monitoring occasions for a PO can span multiple periods of the paging search
space.

The following parameters are used for the calculation of PF and i_s above:

T: DRX cycle of the UE.
If eDRX is not configured as defined in clause 7.4:

| | |
|---|---|
| - | T is determined by the shortest of the UE specific DRX value(s), if |

| | configured by RRC and/or upper layers or provided in PC5-RRC signalling in |
|---|---|
| | case of a L2 U2N Relay UE, and a default DRX value broadcast in system |
| | information. In RRC_IDLE state, if UE specific DRX is not configured by upper |
| | layers, the default value is applied. |
| In RRC_IDLE state, if eDRX is configured by upper layers, i.e., T_{eDRX, CN}, according to | |
| clause 7.4: | |
| - | If T_{eDRX, CN} is no longer than 1024 radio frames: |

| | |
|---|---|
| - | T = T_{eDRX, CN}; |

| | |
|---|---|
| - | else: |

| | |
|---|---|
| - | During CN configured PTW, T is determined by the shortest of UE specific |

DRX value, if configured by upper layers, and the default DRX value broadcast
in system information.

In RRC_INACTIVE state, if eDRX is configured by RRC, i.e., T_{eDRX, RAN}, and/or upper
layers, i.e., T_{eDRX, CN}, as defined in clause 7.4:

| - | If both T_{eDRX, CN} and T_{eDRX, RAN} are no longer than 1024 radio frames, T = |
|---|---|
| min{T_{eDRX, RAN}, T_{eDRX, CN}}. | |
| - | If T_{eDRX, CN} is no longer than 1024 radio frames and no T_{eDRX, RAN} is |
| configured, T is determined by the shortest of UE specific DRX value configured | |
| by RRC and T_{eDRX, CN}. | |
| - | If T_{eDRX, CN} is longer than 1024 radio frames: |

| | |
|---|---|
| - | If T_{eDRX, RAN} is not configured: |

| | |
|---|---|
| - | During CN configured PTW, T is determined by the shortest |

| | |
|---|---|
| | of the UE specific DRX value (s), if configured by RRC and/or upper |
| | layers, and a default DRX value broadcast in system information. |
| | Outside the CN configured PTW, T is determined by the UE specific |
| | DRX value configured by RRC; |
| - | else if T_{eDRX, RAN} is no longer than 1024 radio frames: |

| | |
|---|---|
| - | During CN configured PTW, T is determined by the shortest |

of the UE specific DRX value, if configured by upper layers and
T_{eDRX, RAN}, and a default DRX value broadcast in system information.
Outside the CN configured PTW, T is determined by T_{eDRX, RAN}.

N: number of total paging frames in T
Ns: number of paging occasions for a PF
PF_offset: offset used for PF determination
UE_ID:

| If the UE operates in eDRX as specified in clause 7.4: | |
|---|---|
| - | 5G-S-TMSI mod 4096 |

else:

| | |
|---|---|
| - | 5G-S-TMSI mod 1024 |

Parameters Ns, nAndPagingFrameOffset, nrofPDCCH-MonitoringOccasionPerSSB-InPO,
and the length of default DRX Cycle are signaled in SIB1. The values of N and PF_offset are
derived from the parameter nAndPagingFrameOffset as defined in TS 38.331. The parameter
firstPDCCH-MonitoringOccasionOfPO is signalled in SIB1 for paging in the BWP configured
by initialDownlinkBWP. For paging in a DL BWP other than the BWP configured by
initialDownlinkBWP, the parameter first-PDCCH-MonitoringOccasionOfPO is signaled in the
corresponding BWP configuration.
If the UE has no 5G-S-TMSI, for instance when the UE has not yet registered onto the
network, the UE shall use as default identity UE_ID = 0 in the PF and i_s formulas above.
For NCR-MT, UE_ID = 0 is applied in the PF and i_s formulas above.
5G-S-TMSI is a 48 bit long bit string as defined in TS 23.501. 5G-S-TMSI shall in the formulae
above be interpreted as a binary number where the left most bit represents the most
significant bit.
In RRC_INACTIVE state, if the UE supports inactiveStatePO-Determination and the network
broadcasts ranPagingInIdlePO with value “true”, the UE shall use the same i_s as for
RRC_IDLE state. Otherwise, the UE determines the i_s based on the parameters and formula
above.
In RRC_INACTIVE state, if eDRX value configured by upper layers is no longer than 1024
radio frames, the UE shall use the same i_s as for RRC_IDLE state.
In RRC_INACTIVE state, if eDRX value configured by upper layers is longer than 1024 radio
frames, during CN PTW, the UE shall use the same i_s as for RRC_IDLE state.

### Illustrative Example #2—Using Short Message

TABLE 5
TS38.331 V17.3.0

| | |
|---|---|
| 5.2.2.2.2 | SI change indication and PWS notification |

<OMITTED>
If the UE receives a Short Message, the UE shall:

| | |
|---|---|
| 1> | if the UE is ETWS capable or CMAS capable, the etwsAndCmasIndication bit of Short |

Message is set, and the UE is provided with searchSpaceSIB1 and
searchSpaceOtherSystemInformation on the active BWP or the initial BWP:

| 1> | for NCR-MT: | |
|---|---|---|
| | 2> immediately re-acquire the SIB1; | |
| | 2> | if the UE is ETWS capable and si-SchedulingInfo includes scheduling |
| | information for SIB6: | |
| | | 3> acquire SIB6, as specified in clause 5.2.2.3.2, immediately; |
| | 2> | if the UE is ETWS capable and si-SchedulingInfo includes scheduling |
| | information for SIB7: | |
| | | 3> acquire SIB7, as specified in clause 5.2.2.3.2, immediately; |
| | 2> | if the UE is CMAS capable and si-SchedulingInfo includes scheduling |
| | information for SIB8: | |
| | | 3> acquire SIB8, as specified in clause 5.2.2.3.2, immediately; |
| NOTE: | | In case SIB6, SIB7, or SIB8 overlap with a measurement gap it is left to UE |

implementation how to immediately acquire SIB6, SIB7, or SIB8.

| | |
|---|---|
| 1> | if the UE is not configured with an eDRX cycle longer than the modification period and |

the systemInfoModification bit of Short Message is set:

| | |
|---|---|
| 2> | apply the SI acquisition procedure as defined in clause 5.2.2.3 from the start of |

| | |
|---|---|
| | the next modification period; |
| 1> | if the UE is configured with an RRC_IDLE eDRX cycle longer than the modification |

period and the systemInfoModification-eDRX bit of Short Message is set:

| | |
|---|---|
| 2> | apply the SI acquisition procedure as defined in clause 5.2.2.3 from the start of |

| | |
|---|---|
| | the next eDRX acquisition period boundary. |
| 1> | for NCR-MT: |
| | 2> perform the actions to connect to the cell as defined in clauses 5.3.3 with the |
| | establishment cause ncr-Access |

<OMITTED>

| | |
|---|---|
| 6.5 | Short Message |

Short Messages can be transmitted on PDCCH using P-RNTI with or without associated
Paging message using Short Message field in DCI format 1_0 (see TS 38.212, clause
7.3.1.2.1).
Table 6.5-1 defines Short Messages. Bit 1 is the most significant bit.

TABLE 6.5-1
Short Messages

| Bit | Short Message |
|---|---|
| 1 | systemInfoModification |
| | If set to 1: indication of a BCCH modification other than SIB6, SIB7 and SIB8. |
| 2 | etwsAndCmasIndication |
| | If set to 1: indication of an ETWS primary notification and/or an ETWS |
| | secondary notification and/or a CMAS notification. |
| 3 | stopPagingMonitoring |
| | This bit can be used for only operation with shared spectrum channel access |
| | and if nrofPDCCH-MonitoringOccasionPerSSB-InPO is present. |
| | If set to 1: indication that the UE may stop monitoring PDCCH occasion(s) |
| | for paging in this Paging Occasion as specified in TS 38.304, clause 7.1. |
| 4 | systeminfoModification-eDRX |
| | If set to 1: indication of a BCCH modification other than SIB6, SIB7 and SIB8. |
| | This indication applies only to UEs using eDRX cycle longer than the BCCH |
| | modification period. |
| 5 | paging-NCR |
| | If set to 1: indication that a NCR-MT is paged. This shall be ignored by UEs. |
| 6-8 | Not used in this release of the specification, and shall be ignored by UE if |
| | received. |

### Illustrative Example #3—Using Short Message with NCR RNTI

TABLE 6
TS38.331 V17.3.0

6.5 Short Message
Short Messages can be transmitted on PDCCH using P-RNTI or NCR-RNTI with or without
associated Paging message using Short Message field in DCI format 1_0 (see TS 38.212,
clause 7.3.1.2.1).
Table 6.5-1 defines Short Messages. Bit 1 is the most significant bit.

TABLE 6.5-1
Short Messages

| Bit | Short Message |
|---|---|
| 1 | systemInfoModification |
| | If set to 1: indication of a BCCH modification other than SIB6, SIB7 and SIB8. |
| 2 | etwsAndCmasIndication |
| | If set to 1: indication of an ETWS primary notification and/or an ETWS |
| | secondary notification and/or a CMAS notification. |
| 3 | stopPagingMonitoring |
| | This bit can be used for only operation with shared spectrum channel access |
| | and if nrofPDCCH-MonitoringOccasionPerSSB-InPO is present. |
| | If set to 1: indication that the UE may stop monitoring PDCCH occasion(s) |
| | for paging in this Paging Occasion as specified in TS 38.304 [20], clause 7.1. |
| 4 | systemInfoModification-eDRX |
| | If set to 1: indication of a BCCH modification other than SIB6, SIB7 and SIB8. |
| | This indication applies only to UEs using eDRX cycle longer than the BCCH |
| | modification period. |
| 5-8 | Not used in this release of the specification, and shall be ignored by UE if |
| | received. |

TABLE 6.5-1
Short Messages using NCR-RNTI

| Bit | Short Message |
|---|---|
| 1 | paging-NCR |
| | If set to 1: indication that a NCR-MT is paged. |
| | This shall be ignored by UEs. |
| 2-8 | Not used in this release of the specification, |
| | and shall be ignored by UE if received. |

### Illustrative Example #4—Not Informing Upper Layers

If the upper layers (e.g. NAS) are not informed about the paging and response to paging by the RRC layer, then the RRC layer should inform the upper layers about the RRC's transition to RRC_CONNECTED state so that the NAS can also transition to the appropriate mode.

In this option, if the NAS mode is 5GMM-IDLE, then the NAS will not be aware that the lower layers have gone to connected mode. To solve this issue, when the RRC layer transitions to RRC_CONNECTED state, the RRC should inform the NAS about the transition to connected state and hence the NAS, based on this local indication, should transition to 5GMM-CONNECTED mode although the NAS has not sent any message to transition from 5GMM-IDLE mode to 5GMM-CONNECTED mode. In this case, the NAS should consider that a N1 NAS signaling connection has been established (securely) even though no NAS message has been sent by the UE. Moreover, the NAS, based on a local transition without the sending of any NAS message, should consider that the NAS connection has been securely established and hence re-use the current 5G NAS security context.

In one embodiment (which may be applicable to any of the options or solutions described herein), the NAS should remain in 5GMM-CONNECTED mode with RRC_INACTIVE indication even if the NCR's RRC state is RRC-IDLE. For example, this would be useful when there is RRC-based paging and response without the upper layers (e.g. NAS) being informed as normally a paging procedure would require a NAS message transmission so as for the NAS to move to 5GMM-CONNECTED mode. If the UE NAS remains in 5GMM-CONNECTED mode with RRC-INACTIVE indication (as set out herein) during NCR off, then when the NCR is on and hence the RRC is connected, then the indication from RRC layer about being in connected mode should trigger the NAS to transition from 5GMM-CONNECTED mode with RRC-INACTIVE indication to 5GMM-CONNECTED mode and hence consider that the NAS connection is secure.

TABLE 7
TS38.331 V17.3.0

| | |
|---|---|
| 5.3.2.3 | Reception of the Paging message by the UE or PagingRecord by the L2 U2N |

Remote UE
Upon receiving the Paging message by the UE or receiving PagingRecord from its connected
L2 U2N Relay UE by a L2 U2N Remote UE, the UE shall:

| | |
|---|---|
| 1> | if in RRC_IDLE, for each of the PagingRecord, if any, included in the Paging message, |

or

| | |
|---|---|
| 1> | if in RRC_IDLE, for each of the PagingRecord, if any, included in the |

UuMessageTransferSidelink message received from the connected L2 U2N Relay UE:

| | |
|---|---|
| 2> | if the ue-Identity included in the PagingRecord matches the UE identity allocated |

by upper layers:

| | |
|---|---|
| 3> | if upper layers indicate the support of paging cause: |

| | |
|---|---|
| 4> | forward the ue-Identity, accessType (if present) and paging cause |

| | (if determined) to the upper layers; |
|---|---|
| 3> | else: |

4> for NCR-MT:

5> perform the actions to connect
to the cell as defined in clauses
5.3.3 with the establishment cause ncr-Access

4> else:

5> forward the ue-Identity and accessType (if present) to the upper layers;

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-15. (canceled)

16. A method performed by a network controlled repeater (NCR)-mobile termination (MT) in a wireless communication system, the method comprising:
receiving, from a base station, a paging message including first information on an identity (ID) of the NCR-MT, while the NCR-MT is in a radio resource control (RRC) idle state or an RRC inactive state;
identifying that the NCR-MT is paged based on the first information; and
transmitting, to the base station, an RRC message based on the paging message,
wherein the ID of the NCR-MT is an NCR-specific ID for paging.

17. The method of claim 16, wherein the paging message further includes second information on a paging cause, and
wherein the second information indicates an NCR access.

18. The method of claim 16, further comprising:
disabling an NCR-forward (Fwd) based on the paging message,
wherein the paging message is associated with a radio access network (RAN)-initiated paging.

19. The method of claim 16, wherein a plurality of NCR-MTs including the NCR-MT transit to an RRC connected state based on the paging message, and
wherein a same paging cycle and a same paging occasion are allocated to the plurality of NCR-MTs.

20. A method performed by a base station in a wireless communication system, the method comprising:
identifying to page a network controlled repeater (NCR)-mobile termination (MT) in a radio resource control (RRC) idle state or an RRC inactive state;
transmitting, to the NCR-MT, a paging message including first information on an identity (ID) of the NCR-MT; and
receiving, from the NCR-MT, an RRC message based on the paging message,
wherein the ID of the NCR-MT is an NCR-specific ID for paging.

21. The method of claim 20, wherein the paging message further includes second information on a paging cause, and
wherein the second information indicates an NCR access.

22. The method of claim 20, wherein an NCR-forward (Fwd) is disabled based on the paging message, and
wherein the paging message is associated with a radio access network (RAN)-initiated paging.

23. The method of claim 20, wherein a plurality of NCR-MTs including the NCR-MT transit to an RRC connected state based on the paging message, and
wherein a same paging cycle and a same paging occasion are allocated to the plurality of NCR-MTs.

24. A network controlled repeater (NCR)-mobile termination (MT) in a wireless communication system, the NCR-MT comprising:
a transceiver; and
a controller coupled with the transceiver and configured to:
receive, from a base station, a paging message including first information on an identity (ID) of the NCR-MT, while the NCR-MT is in a radio resource control (RRC) idle state or an RRC inactive state,
identify that the NCR-MT is paged based on the first information, and
transmit, to the base station, an RRC message based on the paging message,
wherein the ID of the NCR-MT is an NCR-specific ID for paging.

25. The NCR-MT of claim 24, wherein the paging message further includes second information on a paging cause, and
wherein the second information indicates an NCR access.

26. The NCR-MT of claim 24, wherein the controller is further configured to:
disable an NCR-forward (Fwd) based on the paging message, and
wherein the paging message is associated with a radio access network (RAN)-initiated paging.

27. The NCR-MT of claim 24, wherein a plurality of NCR-MTs including the NCR-MT transit to an RRC connected state based on the paging message, and
wherein a same paging cycle and a same paging occasion are allocated to the plurality of NCR-MTs.

28. A base station in a wireless communication system, the base station comprising:
a transceiver; and
a controller coupled with the transceiver and configured to:
identify to page a network controlled repeater (NCR)-mobile termination (MT) in a radio resource control (RRC) idle state or an RRC inactive state,
transmit, to the NCR-MT, a paging message including first information on an identity (ID) of the NCR-MT, and
receive, from the NCR-MT, an RRC message based on the paging message, wherein the ID of the NCR-MT is an NCR-specific ID for paging.

29. The base station of claim 28, wherein the paging message further includes second information on a paging cause, and
wherein the second information indicates an NCR access.

30. The base station of claim 28, wherein an NCR-forward (Fwd) is disabled based on the paging message, and
wherein the paging message is associated with a radio access network (RAN)-initiated paging.

31. The base station of claim 28, wherein a plurality of NCR-MTs including the NCR-MT transit to an RRC connected state based on the paging message, and
wherein a same paging cycle and a same paging occasion are allocated to the plurality of NCR-MTs.
